(19) United States
(12) Patent Application Publication
(10) Pub. No.: US 2007/0074038 A1
(43) Pub. Date: Mar. 29, 2007

(54) Method, apparatus and program storage device for providing a secure password manager

(75) Inventors: Robert Thomas Arenburg, Round Rock, TX (US); Sumit Chawla, Portland, OR (US); Amit Mathur, San Jose, CA (US); Chakarat Skawratananond, Austin, TX (US)

Correspondence Address: DAVID W. LYNCH;CHAMBLISS, BAHNER & STOPHEL, 1000 TALLAN SQUARE-S, TWO UNION SQUARE, CHATTANOOGA, TN, 37402, US

(73) Assignee: International Business Machines Corporation

(21) Appl. No.: 11/239,530

(22) Filed: Sep. 29, 2005

(51) Int. Cl. H04L 9/00

(52) U.S. Cl. 713/181

(57) ABSTRACT

A method, apparatus and program storage device for providing a secure password manager. A password manager provides a database comprising a header and N slots. An indicator is stored in a predetermine position of the header for identifying a number of valid password entries for the record. A hash value based on the content of the N slots is calculated and stored in the header. The data in the data structure is fed along with a master password through a key generator to create encrypted data.

### BACKGROUND OF INVENTION

1. Field of the Invention.

This invention relates in general to computer security and authentication, and more particularly to a method, apparatus and program storage device for providing a secure password manager.

2. Description of Related Art.

Today's information systems contain private information, individually sensitive information or personalized information, so they require users to identify themselves, using login credentials such as username and password, before access to the secured information is granted. Similarly, many information systems require their users to identify themselves before authorization and billing procedures. However, most information systems do not share login credentials and therefore a user that uses several information systems needs to be able to supply the correct login credentials to each information system that he or she wishes to use. This creates several practical problems since the user of multiple information systems needs to remember or record his or her login credentials for each information system, e.g., for online accounts, credit card sites, etc.

The foundation for secure identity management is identity, and a key component of user identity is the set of aforementioned passwords. As a result, password management, including the ability to effectively and efficiently manage passwords as a critical part of the user's identity, is a key component of identity management. Password management leverages the user's identity to provide secure access to resources for both internal and external users.

It should be noted that the term “password” is being used in this application to denote any piece of information that can be used for authentication purposes. PIN codes, social security numbers, pass-phrases, etc. all fall under this category.

Password management, however, is becoming more difficult as organizations rapidly increase the complexity of their IT infrastructures by adding applications and services-each with a separate login process. Users have to remember a large and growing number of passwords to access the resources they need and administrators have to manage those passwords. The result is lower user productivity, increased security risks, and higher system administration and support costs.

A common habit of users burdened with a large number of passwords is to use a single password across multiple sites. This can cause a breach in security for even the most secure systems. For example, if a user uses the same password for online banking and a public e-mail account, breaking the e-mail account security may be easier for a hacker than getting through the security of online bank. But the hacker now controls both accounts, due to the common password. Hence, it is important to provide a way for users to manage multiple passwords.

The earliest solutions for these problems included writing down various passwords on a paper, or storing them in a text file. Neither writing passwords on paper nor storing passwords in a text file is secure, since anyone with access to the paper or the text file can get access to all online accounts. Software utilities have been developed for managing passwords by storing the identity validation information of the different systems and entering it whenever the user accesses any of those systems. These tools are called password managers and some of them are even integrated into popular browsers like Internet Explorer and Mozilla Firefox.

Password managing utilities have two major shortcomings. First, since the information is stored locally, these systems only work on the computer on which they are installed. Whenever a user needs to access any of the information systems from a different computer, these utilities obviously become ineffective. Second, having the identification information stored on the computer exposes it to possible intrusions and break-ins by hackers or other people with access to the computer.

More recently, software-based solutions have been released, which allow customers to keep passwords in a “database”. This “database” is kept on a non-volatile medium, frequently the hard disk, and can be as simple as a text file with comma-separated entries, or a custom binary format that “hides” the passwords. Note that the term “database” is used in a very loose manner by such password manager, since bundling an enterprise-strength database with a password manager application would make the application extremely large and difficult to manage. So, the terms “database” and “file” are used interchangeably in this filing, to refer to the file-based storage of passwords.

The problem with existing solutions is two-fold. First, a weak or non-existent password is used to generate the key that is used to encode the password. For example, browsers frequently cache the password, providing the “convenience” that the user is not prompted for password. This reduces the security of the solution to the level of the underlying operating system (while also affecting the portability of the approach). Second, it is common to encrypt only the passwords, leaving it possible for hackers to guess how many entries are present in the database. As a common key is used to encode all passwords within the entire database, these solutions are prone to “Known-password” attacks. If the hackers are able to obtain the password for one entry (either through entrapment, guessing or dictionary-based attacks), they now have the original password and the encrypted password for the entry, making it trivial for them to find out the key used for encrypting the passwords. They can then use this key to decrypt all other passwords in the database.

It can be seen that there is a need for a method, apparatus and program storage device for providing a secure password manager.

### SUMMARY OF THE INVENTION

To overcome the limitations in the prior art described above, and to overcome other limitations that will become apparent upon reading and understanding the present specification, the present invention discloses a method, apparatus and program storage device for providing a secure password manager.

The present invention solves the above-described problems by combining the portability of file-based password storage with protection against known-password attacks. The password manager allows users to copy their password files onto a portable storage such as a USB key for mobility.

A method for managing passwords in accordance with an embodiment of the present invention includes providing a data structure comprising a header and N slots, providing an indicator in a predetermined position of the header for identifying a number of valid password entries for the data structure, writing R*N random bytes of data to the N slots, wherein R is the size of each slot, calculating a hash value based on the content of the N slots, storing the calculated hash value in the header and feeding data in the data structure and a master password through a key generator to create encrypted data.

In another embodiment of the present invention, an apparatus for securing passwords is provided. The apparatus includes memory for implementing a password repository and a processor, coupled to the memory, for executing the programs of instructions and for accessing the password repository, wherein the programs of instructions comprise a software application component for securing passwords against attack attempting to obtain passwords, the software application component being adapted for instantiating a password manager configured for providing a data structure comprising a header and N slots, providing an indicator in a predetermined position of the header for identifying a number of valid password entries for the data structure, writing R*N random bytes of data to the N slots, wherein R is the size of each slot, calculating a hash value based on the content of the N slots, storing the calculated hash value in the header and feeding data in the data structure and a master password through a key generator to create encrypted data.

In another embodiment of the present invention, a program storage device is provided. The program storage device includes program instructions executable by a processing device to perform operations for providing a secure password manager, the operations including providing a data structure comprising a header and N slots, providing an indicator in a predetermined position of the header for identifying a number of valid password entries for the data structure, writing R*N random bytes of data to the N slots, wherein R is the size of each slot, calculating a hash value based on the content of the N slots, storing the calculated hash value in the header and feeding data in the data structure and a master password through a key generator to create encrypted data.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 is a block diagram of an environment of a password manager according to an embodiment of the present invention;

FIG. 2 is a schematic block diagram of a computer system, which may provide an operating environment according to an embodiment of the present invention;

FIG. 3 illustrates a password manger according to an embodiment of the present invention;

FIG. 4 illustrates a password record according to an embodiment of the present invention;

FIG. 5 illustrates the structure for the data of the password manager according to an embodiment of the present invention;

FIG. 6 illustrates a block diagram of the encryption process according to an embodiment of the present invention;

FIG. 7 is a flow chart showing the initial configuring of the password database according to an embodiment of the present invention;

FIG. 8 is a flow chart of the method for securing passwords when a new entry is created according to an embodiment of the present invention;

FIG. 9 is a flow chart of the method for detecting whether data has been tampered with according to an embodiment of the present invention; and

FIG. 10 illustrates a system according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for providing a secure password manager. The portability of file-based password storage is combined with protection against known-password attacks. The password manager allows users to copy their password files onto a portable storage such as a USB key for mobility.

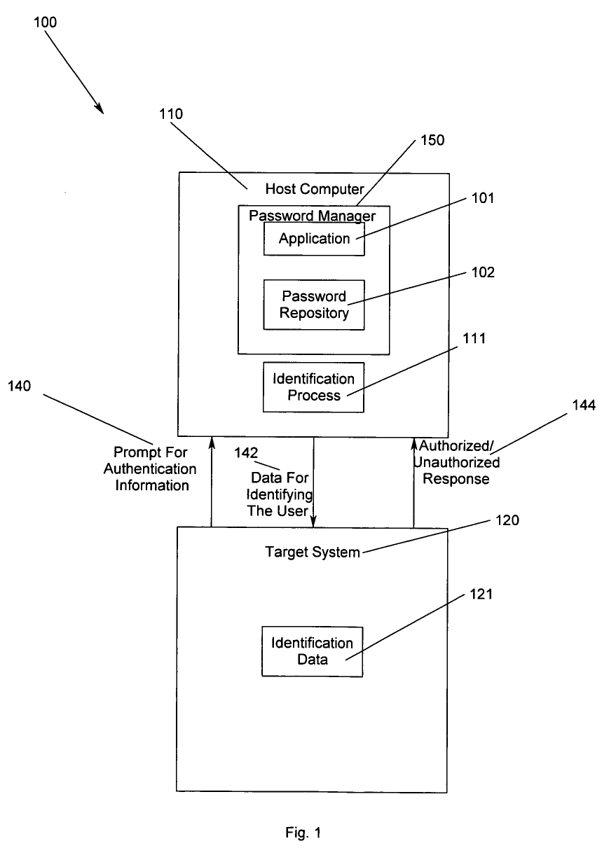

FIG. 1 is a block diagram of an environment 100 according to an embodiment of the present invention. As illustrated in FIG. 1, the operational environment 100 includes a password manager 150. The password manager 150 includes a password repository that implements the password database according to an embodiment of the present invention. The password manager 150 also includes a software application component 101 that manages the password manager 150. The host computer 110 runs an identification process 111 that is used to communicate with a target system 120. The target system 120 includes identification data 121, which is used to verify the identity of the user. As the target system 120 sends a prompt 140 to the host computer 110 for authentication information, the password manager 150 reads the request, and sends the required information to the host computer 110. The data for identifying the user 142 is then sent to the target system 120. The target system 120 responds with “Authorized/Unauthorized” 144 based on whether the user was identified or not. The application component 102 is responsible for instantiating the password manager 150. The software application 102 sets up the password manager 150 for connecting to the target system 120 and for performing the password management encoding and decoding according to an embodiment of the present invention.

Those skilled in the art will recognize that the present invention is not meant to be limited to the structure illustrated in FIG. 1, but rather the structure of FIG. 1 is provided for the purpose of illustration only. Indeed, those skilled in the art will recognize that other alternative environments may be used without departing from the scope of the present invention. For example, the password manager 150 may be implemented in a portable device that communicates with the host computer 110. The activation of Password Manager 150 may be manual or automatic. Other variations are possible without departing from the scope of the present invention.

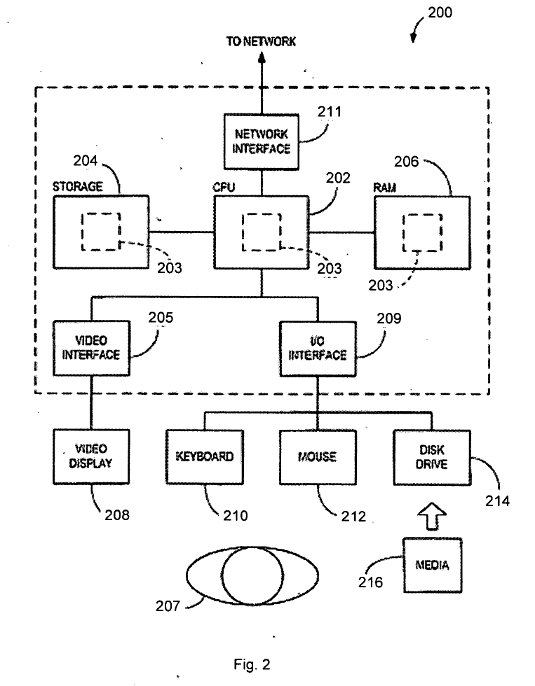

FIG. 2 illustrates a computer system 200 that may provide an operating environment for an embodiment of the present invention. The computer system 200 may include a central processing unit (“CPU”) 202 connected to a storage unit 204 and to a random access memory (“RAM”) 206. The CPU 202 may execute a software program 203 which may be stored in the storage unit 204 and loaded into RAM 206 as required. A user 207 may interact with the computer system 200 using a video display 208 connected to system 200 via a video interface 205, and various input/output devices such as a keyboard 210, mouse 212, and disk drive 214 connected by an I/O interface 209. The disk drive 214 may be configured to accept or include computer readable media 216. Optionally, the computer system 200 may be network enabled via a network interface 211. The computer readable media 216, as will be described in greater detail below, may be configured to provide instructions, that when executed by CPU 202 performs operations for providing a secure password manager. Furthermore, a portable version of the password manager application may be provided so an installation of password manager on a local machine is not required and thus the password manager may be used on different computer systems.

Those skilled in the art will also recognize that the environment illustrated in FIG. 2 is not intended to limit the present invention. Indeed, those skilled in the art will recognize that other alternative hardware environments may be used without departing from the scope of the present invention.

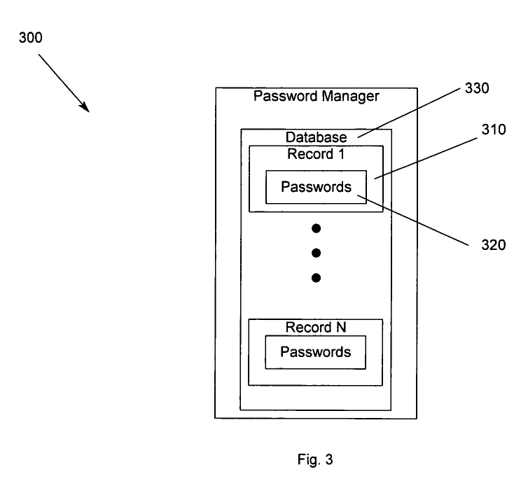

FIG. 3 illustrates a password manger 300 according to an embodiment of the present invention. The password manager 300 includes a record 310 for maintaining password information 320. Each of the records 310 has a fixed length instead of a “Tag-Length-Value” format, and a pre-determined set of fixed-length records is created during installation. Thus, the password manager, during installation, calculates the total amount of storage space required for the database 330 of password records 310.

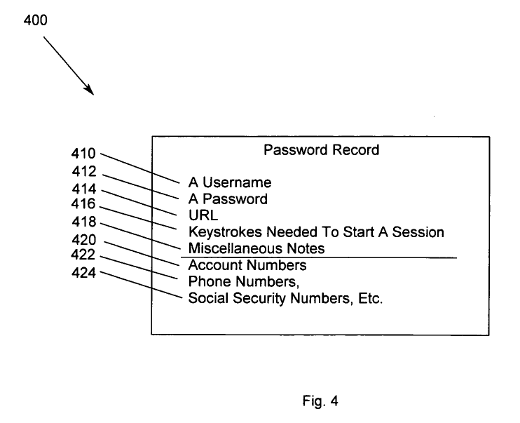

FIG. 4 illustrates a password record 400 according to an embodiment of the present invention. The password record 400 may include, for example, a username 410, a password 412, URL 414, keystrokes needed to start a session 416, and miscellaneous notes 418. While the present invention is illustrated with reference to securing passwords, the present invention is not meant to be limited to only password storage. Other forms of information that needs to be secured could also, or alternatively, be secured by employing one or more embodiments of the present invention. For example, the password record could also be used to store additional information that needs to be secured, such as online bank and other account numbers 420, phone numbers 422, social security numbers 424, etc.

The total amount of storage space required for the database depends upon the number of records, the size of each record and a predetermined amount of storage for header information. The total storage space may be calculated according to:
S=R*N+H;
wherein S is the total amount of storage space, in bytes, required for the password database, R is the size of each record and N is a predetermined large number, e.g., 1000. N is actually equal to the number of passwords that can be handled plus 1. The strength of the proposed method is inversely proportional to the value of N. Accordingly, the value for N should be set to a sufficiently high value. H is the space needed to store some header information.

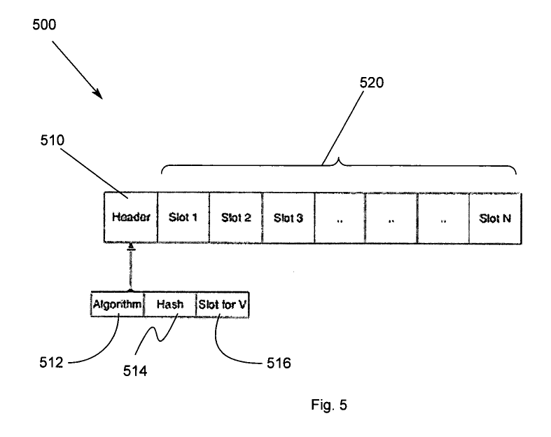

FIG. 5 illustrates the data structure 500 for the data of the password manager according to an embodiment of the present invention. The data structure 500 of FIG. 5 includes a header 510, and N slots 520. The header 520 includes space for data to identify the key generation algorithm 512, a hash value 514 and an initial placeholder that include the index of slot V 516, which thereafter the position of slot V is randomly selected. Slot V is used to store the count of valid password entries.

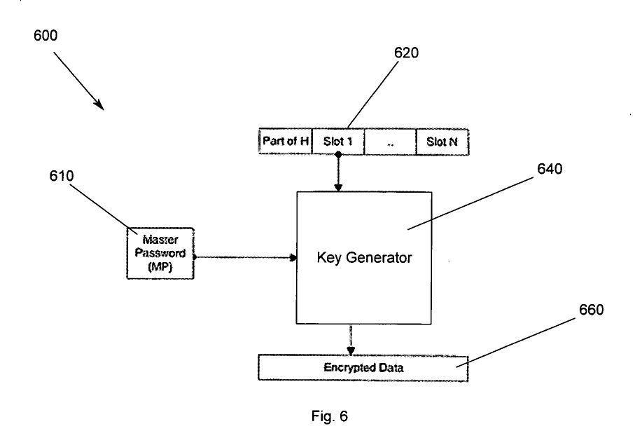

FIG. 6 illustrates a block diagram 600 of the encryption process according to an embodiment of the present invention. In FIG. 6, a master password 610 is provided to a key generator 640. The content of the password database 620 is also provided to the key generator 640. The key generator 640 uses the previously selected key generation algorithm (e.g., based on algorithm bits 512 shown in the header of FIG. 5) with the master password 610 to generate a non-repeating key, using which the contents of the password database 620 are encoded to generate the encrypted database 660. The algorithm bits 512 shown in the header of FIG. 5 are not fed through the key generator 640, but the content of Slot V 516 is.

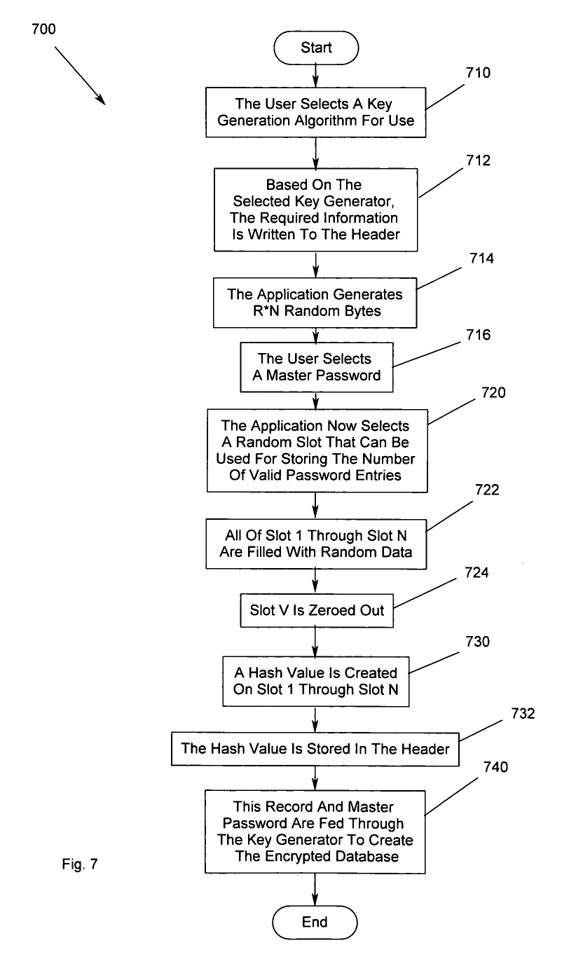

FIG. 7 is a flow chart 700 showing the initial configuring of the password database according to an embodiment of the present invention. Reference to FIG. 5 will be made when describing FIG. 7. At install time, the user may select a key generation algorithm for use 710. The implementation of this key generation algorithm is referred to as a key generator. For example, an RSA Generator could be set as the default key generator for the application. The key generator can be a public algorithm, which allows a non-repeating set of bits, for use as key, to be generated. Based on the selected key generator, the required information is written to the header H (see Header 510 in FIG. 5) 712.

As newer, more secure key generators become available, a new key generator can be added to the list without modifying the method or apparatus discussed here. This allows the Password Manager to remain independent of key generation algorithms. It should be noted that a weak key generator will reduce or eliminate the effectiveness of the proposed method. Hence, due diligence must be applied when selecting a key generator.

Also at install time, the application generates R*N random bytes 714, using any secure mechanism publicly available. The only criterion for the random generation of R*N bytes is that the bits should be sufficiently random. This serves as the initial contents of the database. The user selects a master password 716. The master password may be either a word or passphrase, but must be something that the user must never forget and must never share. The only piece of information that secures the entire set of passwords is the master password (MP). There is no protection, either in the present invention, or elsewhere, for a stolen master password because there is no other way to decrypt the encrypted password database. It is possible to use Biometrics or other authentication mechanisms for providing the master password. The proposed method does not have a dependency on the Master Password generation.

The application now selects a random slot (from N slots 520 shown in FIG. 5) that can be used for storing the number of valid password entries, V 720. The use of a slot for the password count is the reason why the absolute maximum number of passwords is restricted to N−1, not N. Slot V, i.e., the entry showing the number of valid passwords, is encrypted, even for the case when no entries are present in the password database. The index of Slot V itself is stored in the header (510 in FIG. 5), and is also encrypted. thus, in order to find out the number of passwords in the password database, a hacker would need to first decrypt the index V, and then decrypt the slot V itself. The indirection, combined with a strong key generator, makes the determination of password counts extremely difficult.

At this time, all of Slot 1 through Slot N is filled with random data 722, and Slot V, the randomly chosen slot chosen from the N slots 520 shown in FIG. 5, is zeroed out 724. The size of each slot is R, and the initial slot (containing the header) will be a different size, based on the amount of information needed to store for the key generator algorithm, the index of Slot V (516 in FIG. 5), and the hash (514 in FIG. 5). Note that the algorithm information is unencrypted and must not be considered unattainable. There is no benefit in trying to hide this detail for protecting the contents. A hash value is created on Slot 1 through Slot N 730 (which is unencrypted at this stage) and stored in the header 732 (i.e., Hash 514 shown in FIG. 5). The hash can be any known hashing function like MD5, SHA (Secure Hash Algorithm), etc. The header could also contain an entry identifying the hashing function if needed. This data is now fed through the key generator, using MP, to create the encrypted database 740. As stated above, the algorithm bits are not fed through the key generator, but the index of Slot V is fed through the key generator. In other words, after encryption, it should not be possible for a hacker to detect the number of valid password entries in the database.

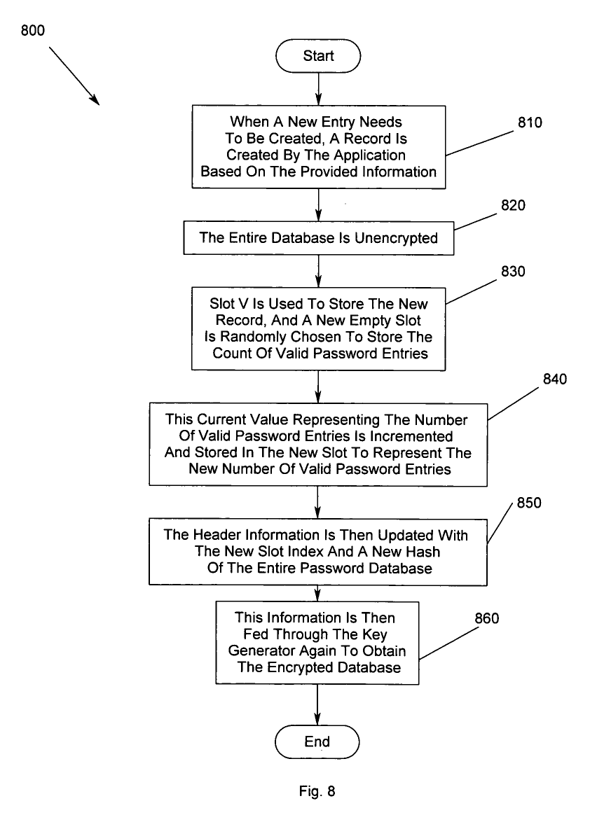

FIG. 8 is a flow chart 800 of the method for securing passwords when a new entry is created according to an embodiment of the present invention. When a new entry needs to be created, a record is created by the application based on the provided information 810. Then the entire database is unencrypted 820 using the master password. This is time-consuming, hence, it is important not to specify too large a value for N. However, the strength of the method according to an embodiment of the present invention is directly proportional to the ratio V/N; i.e., the number of valid password entries to the number of slots. The security becomes better as the ratio become smaller. This is the well-established art of steganography, i.e., the amount of “noise” makes the job of locating valid data difficult.

Now, slot V, which is identified by the index for Slot V that is stored in the header, is used to store the new record, and a new empty slot V (Where is this one?) is randomly chosen from the N slots 520 shown in FIG. 5, to store the count of valid password entries 830. This current value representing the number of valid password entries is incremented and stored in the new slot to represent the new number of valid password entries 840. The index for Slot V 516 in the header 510 as shown in FIG. 5, is then updated to indicate the position of the new slot V and a new hash (514 as shown in FIG. 5)for the entire password database is calculated 850. The unencrypted information is then fed through the key generator again to obtain the encrypted database 860.

The method for securing passwords according to an embodiment of the present invention protects against known password attacks. For example, if the hacker is looking at the encrypted file, the hacker cannot identify which entries in the file are valid, even if R and N are known. If the hacker observes the N slots (520 as shown in FIG. 5) and detects a change representing the change for slot V, it is possible to obtain the first few bytes of the key being generated. However, the key generator being used here generates a key of almost S bytes in length, i.e., R*N+H, so even if the first few bits are known, the next bits cannot be generated.

If the hacker examines a new password database file that has one more entry, the changes between the two files will be very large. This is based upon the selection of a good hash function since a good hash function will modify the hash (and as a result, the encrypted database) so drastically, for even single-bit changes in unencrypted data, that there will be no comparison possible between the two database files. The strength of this protection is, thus, also dependent on selection of good hash function and key generator.

Accordingly, a hacker cannot launch a “known-password” attack, and cannot use the delta between two files to detect the changes. This results in a secure database that is portable. As long as the master password (MP) is secure, sufficiently large value for N is selected and good key generation and hashing functions are used, the password manager according to an embodiment of the present invention will be protected against attacks.

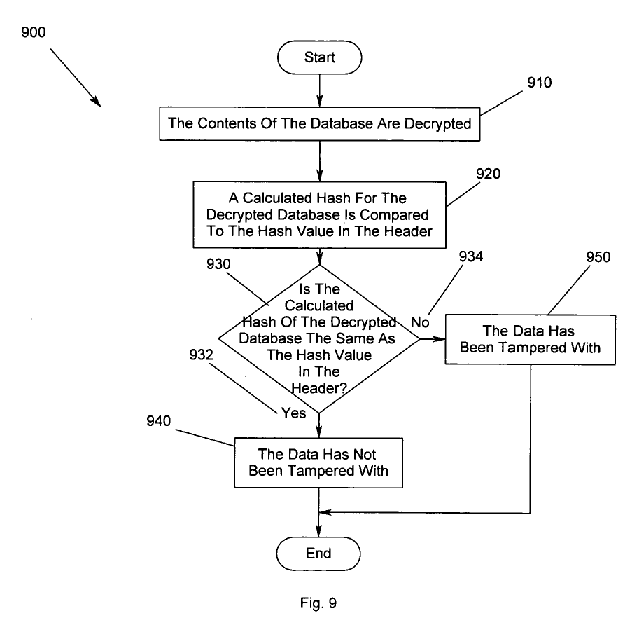

FIG. 9 is a flow chart 900 of the method for detecting whether data has been tampered with according to an embodiment of the present invention. In FIG. 9, the contents of the database are decrypted 910. A hash for the decrypted database is calculated and then the calculated hash of the decrypted database is compared to the hash value stored in the header 920. A determination is made whether the calculated hash of decrypted database matches the hash value in the header930. If the calculated hash matches the hash in the header 932, the data has not been tampered with 940. If the calculated hash of decrypted database does not match the hash in the header 934, the data has been tampered with 950. Accordingly, any modifications to the data are immediately detected upon decryption, as the stored hash data will not match the hash of decrypted output. Thus, the method for securing passwords according to an embodiment of the present invention also provides the added advantage of being able to detect whether the data has been tampered with.

Note that if the master password is lost, there is no way the passwords can be recovered. This is a major strength of the proposed solution, as it simplifies password management to a single Master Password, while ensuring that selection of passwords for one entity does not have any effect on the security of another entity.

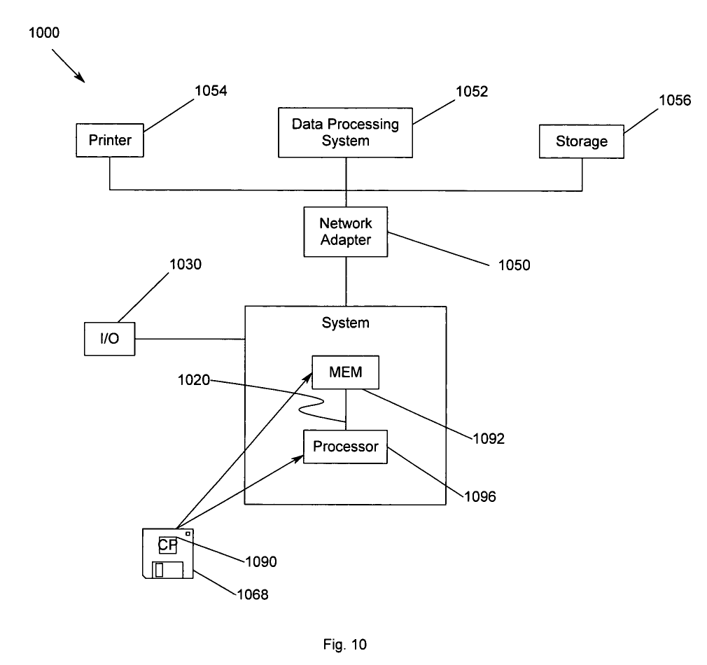

FIG. 10 illustrates a system 1000 according to an embodiment of the present invention. Embodiments of the present invention may take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, embodiments of the present invention may take the form of a computer program product 1090 accessible from a computer-usable or computer-readable medium 1068 providing program code for use by or in connection with a computer or any instruction execution system.

For the purposes of this description, a computer-usable or computer readable medium 1068 can be any apparatus that can contain, store, communicate, propagate, or transport the program for use by or in connection with the instruction execution system, apparatus, or device. The medium 1068 may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A system suitable for storing and/or executing program code will include at least one processor 1096 coupled directly or indirectly to memory elements 1092 through a system bus 1020. The memory elements 1092 can include local memory employed during actual execution of the program code, bulk storage, and cache memories which provide temporary storage of at least some program code in order to reduce the number of times code must be retrieved from bulk storage during execution.

Input/output or I/O devices 1040 (including but not limited to keyboards, displays, pointing devices, etc.) can be coupled to the system either directly to the system or through intervening I/O controllers.

Network adapters 1050 may also be coupled to the system to enable the system to become coupled to other data processing systems 1052, remote printers 1054 or storage devices 1056 through intervening private or public networks 1060. Modems, cable modem and Ethernet cards are just a few of the currently available types of network adapters.

Accordingly, the computer program 1090 comprise instructions which, when read and executed by the system 1000 of FIG. 10, causes the system 1000 to perform the steps necessary to execute the steps or elements of the present invention

The foregoing description of the embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method for managing passwords, comprising:
providing a data structure comprising a header and N slots;
providing an indicator in a predetermined position of the header for identifying a number of valid password entries for the data structure;
writing R*N random bytes of data to the N slots, wherein R is the size of each slot;
calculating a hash value based on the content of the N slots;
storing the calculated hash value in the header; and
feeding data in the data structure and a master password through a key generator to create encrypted data.

2. The method of claim 1, wherein the providing an indicator further comprises initially zeroing the values of the predetermine position in the header.

3. The method of claim 1, wherein the generating R*N random bytes further comprises generating R*N random bytes using a publicly available secure mechanism.

4. The method of claim 1, further comprising selecting by user a key generation algorithm for use and storing the key generation algorithm in the header.

5. The method of claim 1, further comprising:
receiving a new data entry for storing;
creating a record based upon the received new data entry;
decrypting the entire data structure;
storing the new record in the predetermined position of the header;
randomly selecting a new slot;
incrementing the indicator;
storing the incremented indicator in the randomly selected new slot;
updating the header; and
feeding data in the data structure and the master password through a key generator to create new encrypted data.

6. The method of claim 1 further comprising determining whether the encrypted data has been tampered with.

7. The method of claim 1, wherein the determining whether the encrypted data has been tampered with further comprises:
decrypting the contents of the data structure;
calculating a hash for the N slots of the decrypted data structure;
comparing the calculated hash for the N slots of the decrypted data structure to the hash value in the header; and
determining that the decrypted record has been tampered with when the calculated hash for the N slots of the decrypted data structure does not match the hash value in the header.

8. An apparatus for securing passwords, comprising:
memory for implementing a password repository; and
a processor, coupled to the memory, for executing the programs of instructions and for accessing the password repository, wherein the programs of instructions comprise a software application component for securing passwords against attack attempting to obtain passwords, the software application component being adapted for instantiating a password manager configured for providing a data structure comprising a header and N slots, providing an indicator in a predetermined position of the header for identifying a number of valid password entries for the data structure, writing R*N random bytes of data to the N slots, wherein R is the size of each slot, calculating a hash value based on the content of the N slots, storing the calculated hash value in the header and feeding data in the data structure and a master password through a key generator to create encrypted data.

9. The apparatus of claim 8, wherein the software application component is further adapted for enabling the password manager to initially zero the value of the predetermine position in the header.

10. The apparatus of claim 8, wherein the software application component is further adapted for enabling the password manager to store the key generation algorithm in the header.

11. The apparatus of claim 8, wherein the software application component is further adapted for enabling the password manager to receive a new data entry for storing, to create a record based upon the received new data entry, to decrypt the entire data structure, to store the new record in the predetermined position of the header, to randomly select a new slot, to increment the indicator, to store the incremented indicator in the randomly selected new slot, to update the header and to feed data in the data structure and the master password through a key generator to create new encrypted data.

12. The apparatus of claim 8, wherein the software application component is further adapted for generating R*N random bytes using a publicly available secure mechanism.

13. The apparatus of claim 8, wherein the software application component is further adapted for enabling the password manager to determine whether the encrypted data structure has been tampered with by decrypting the contents of the data structure, calculating a hash for the N slots of the decrypted data structure, comparing the calculated hash for the N slots of the decrypted data structure to the hash value in the header and determining that the decrypted record has been tampered with when the calculated hash for the N slots of the decrypted data structure does not match the hash value in the header.

14. A program storage device, comprising:
program instructions executable by a processing device to perform operations for providing a secure password manager, the operations comprising:
providing a data structure comprising a header and N slots;
providing an indicator in a predetermined position of the header for identifying a number of valid password entries for the data structure;
writing R*N random bytes of data to the N slots, wherein R is the size of each slot;
calculating a hash value based on the content of the N slots;
storing the calculated hash value in the header; and
feeding data in the data structure and a master password through a key generator to create encrypted data.

15. The program storage device of claim 14, wherein the providing an indicator further comprises initially zeroing the values of the predetermine position in the header.

16. The program storage device of claim 14, wherein the generating R*N random bytes further comprises generating R*N random bytes using a publicly available secure mechanism.

17. The program storage device of claim 14, further comprising selecting by user a key generation algorithm for use and storing the key generation algorithm in the header.

18. The program storage device of claim 14, further comprising:
receiving a new data entry for storing;
creating a record based upon the received new data entry;
decrypting the entire database;
storing the new record in the predetermined position of the header;
randomly selecting a new slot;
incrementing the indicator;
storing the incremented indicator in the randomly selected new slot;
updating the header; and
feeding data in the data structure and the master password through a key generator to create new encrypted data.

19. The program storage device of claim 14 further comprising determining whether the encrypted data has been tampered with.

20. The program storage device of claim 14, wherein the determining whether the encrypted data has been tampered with further comprises:
decrypting the contents of the data structure;
calculating a hash for the N slots of the decrypted data structure;
comparing the calculated hash for the N slots of the decrypted data structure to the hash value in the header; and
determining that the decrypted record has been tampered with when the calculated hash for the N slots of the decrypted data structure does not match the hash value in the header.
